(19) United States
(12) Patent Application Publication
(10) Pub. No.: US 2026/0089737 A1
(43) Pub. Date: Mar. 26, 2026

(54) METHODS AND APPARATUSES FOR TIMELINE MANAGEMENT ON UNIFIED TCI INDICATIONS

(71) Applicant: InterDigital Patent Holdings, Inc., Wilmington, DE (US)

(72) Inventors: Jonghyun Park, Syosset, NY (US); Afshin Haghighat, Ile-Bizard (CA); Moon-il Lee, Melville, NY (US)

(73) Assignee: InterDigital Patent Holdings, Inc., Wilmington, DE (US)

(21) Appl. No.: 19/109,239

(22) PCT Filed: Sep. 29, 2023
(86) PCT No.: PCT/US2023/034180

§ 371 Date: Mar. 6, 2025

Related U.S. Application Data
(60) Provisional application No. 63/411,475, filed on Sep. 29, 2022.
(60) Provisional application No. 63/465,747, filed on May 11, 2023.

(51) Int. Cl. H04W 72/232; H04L 1/1812; H04L 5/00

(52) U.S. Cl. CPC H04W 72/232; H04L 1/1812; H04L 5/0091

(57) ABSTRACT

Methods, apparatuses, and procedures for timeline management on transmission configuration indications in wireless communications are disclosed. For example, a method implemented by a wireless transmit/receive unit (WTRU) includes receiving configuration information indicating a set of transmission configuration indicator (TCI) states, a beam application time (BAT), and a BAT offset; receiving downlink control information (DCI) indicating scheduling of a downlink data transmission and a TCI state from the set of TCI states; and transmitting a transmission using the indicated TCI state, and the transmission is transmitted on at least a time offset associated with the BAT and/or the BAT offset after transmitting a hybrid automatic repeat request (HARQ) feedback associated with the downlink data transmission.

### CROSS-REFERENCE TO RELATED APPLICATIONS

This application claims priority to and the benefit of U.S. Provisional Application No. 63/411,475 filed in the U.S. Patent and Trademark Office on Sep. 29, 2022, and U.S. Provisional Application No. 63/465,747 filed in the U.S. Patent and Trademark Office on May 11, 2023, the entire contents of each of which being incorporated herein by reference as if fully set forth below in their entirety and for all applicable purposes.

### BACKGROUND

In some cellular/wireless standards (e.g., 3GPP Release 16, Release 17, Release 18, and/or beyond), continued evolution of 5G New Radio (NR) may continue to optimize management and enhance performance for wireless communications.

In 3GPP Release 17, a unified transmission configuration indicator (TCI) framework is supported. For example, a unified TCI (e.g., joint or a pair of separate DL/UL) may be indicated and/or maintained at a wireless transmit/receive unit (WTRU), to be applicable for both control and/or data channels simultaneously. This is different from an individual beam control per channel (e.g., up to 3GPP Release 16).

In 3GPP Release 16 and/or 17, multi-transmission/reception point (MTRP) is supported. In an example, multi-DCI based MTRP (MDCI-MTRP) is based on CORESETPoolIndex=0 or 1, to support eMBB. In another example, single-DCI based MTRP (SDCI-MTRP) is based on associating up to two TCI-states for a codepoint of TCI field in a DCI, for repeated transmissions across TRPs to achieve reliability enhancements.

In 3GPP Release 18, MIMO WID (RP-213598) captures one relevant aspect: specify extension of Rel-17 unified TCI framework for indication of multiple DL and UL TCI states focusing on multi-TRP use case, using Rel-17 unified TCI framework.

### SUMMARY

Embodiments disclosed herein generally relate to communication networks, wireless and/or wired. One or more embodiments disclosed herein are related to methods, apparatuses, and procedures for timeline management on TCI indications in wireless communications (e.g., in a 5G NR network).

In one embodiment, a method implemented by a wireless transmit/receive unit (WTRU) for wireless communications, the method includes receiving configuration information indicating a set of transmission configuration indicator (TCI) states, a beam application time (BAT), and a BAT offset. The method includes receiving downlink control information (DCI) indicating scheduling of a downlink data transmission and a TCI state from the set of TCI states. The method also includes transmitting a transmission using the indicated TCI state, and the transmission is transmitted on at least a time offset associated with the BAT and/or the BAT offset after transmitting hybrid automatic repeat request (HARQ) feedback associated with the downlink data transmission.

In one embodiment, a method implemented by a wireless transmit/receive unit (WTRU) for wireless communications, the method includes receiving configuration information indicating a set of TCI states, a BAT, and a BAT offset. The method includes receiving DCI indicating scheduling of a downlink data transmission and a TCI state from the set of TCI states. The method also includes receiving a transmission using the indicated TCI state, and the transmission is received on at least a time offset associated with the BAT and/or the BAT offset after transmitting HARQ feedback associated with the downlink data transmission.

In one embodiment, a WTRU for wireless communications comprising circuitry, including a processor, a receiver, a transmitter, and memory, is configured to 1) receive configuration information indicating a set of TCI states, a BAT, and a BAT offset; 2) receive DCI indicating scheduling of a downlink data transmission and a TCI state from the set of TCI states; and 3) transmit a transmission using the indicated TCI state, wherein the transmission is transmitted on at least a time offset associated with the BAT and/or the BAT offset after transmitting HARQ feedback associated with the downlink data transmission.

In one embodiment, a WTRU for wireless communications comprising circuitry, including a processor, a receiver, a transmitter, and memory, is configured to 1) receive configuration information indicating a set of TCI states, a BAT, and a BAT offset; 2) receive DCI indicating scheduling of a downlink data transmission and a TCI state from the set of TCI states; and 3) receive a transmission using the indicated TCI state, wherein the transmission is received on at least a time offset associated with the BAT and/or the BAT offset after transmitting HARQ feedback associated with the downlink data transmission.

In representative embodiments, a WTRU is configured with a parameter of beam application time (BAT) and a paired/associated offset parameter of ‘Delta’, where each of the BAT and the ‘BAT plus Delta’ may be associated with a list of channel(s)/signals which may be predefined, determined based on WTRU capability, and/or configurable independently by network (e.g., a gNB). In an example, the WTRU may be configured with the BAT associated with a first list of channel(s)/signal(s), and be configured with the Delta where the BAT plus Delta may be associated with a second list of channel(s)/signal(s). In an example, in response to receiving a control command (e.g., via a DCI, via a TCI field of a DCI), at a first time instance (T1) indicating at least one unified TCI (UTCI), the WTRU may determine a second time instance (T2), based on the T1 and the BAT (e.g., as T1+BAT, or as T1+Alpha+BAT), on which the WTRU may update (and/or start to use) the indicated at least one UTCI for the first list of channel(s)/signal(s), and not update (at T2) the indicated at least one UTCI for other channels/signals not included in the first list. In an example, the WTRU may determine a third time instance (T3), based on the T1, BAT, and Delta (e.g., as T1+BAT+Delta, or as T1+Alpha+BAT+Delta), on which the WTRU may update (and start to use) the indicated at least one UTCI for the second list of channel(s)/signal(s), and not update (at T3) the indicated at least one UTCI for other channels/signals not included in the second list.

In representative embodiments, a WTRU determines that the time offset is the BAT when (or based on) a type of the channel (or signal) is a first type of channel (or signal) or is included in a first set of channel (or signal) types. The WTRU may determine that the time offset is the BAT plus the BAT offset when the type of the channel or signal is a second type of channel or signal or is included in a second set of channel or signal types. In an example, the WTRU may determine i) the first type of channel or signal is at least one of an SRS or a CSI-RS (e.g., for channel acquisition) or a data channel associated with a low-latency related type (e.g., URLLC) and ii) the second type of channel or signal is at least one of a PUSCH, a PDSCH, or a control channel (e.g., CORESET, PDCCH, search space, or PUCCH, etc.).

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a diagram illustrating an example timeline of using a beam application time (BAT) or a paired/associated offset parameter (delta) for indicated UTCI(s), according to one or more embodiments;

FIG. 3 is a diagram illustrating an example timeline of using a BAT or a paired/associated offset parameter (delta) for a coherent joint transmission (CJT) operation, according to one or more embodiments;

FIG. 4 is a diagram illustrating a first example of a management procedure including determining a type of a channel or signal for wireless communications, according to one or more embodiments; and

FIG. 5 is a diagram illustrating a second example of a transmission/reception management procedure including determining and using time offset(s) and type(s) of channel or signal for wireless communications, according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System, Networks, and Devices

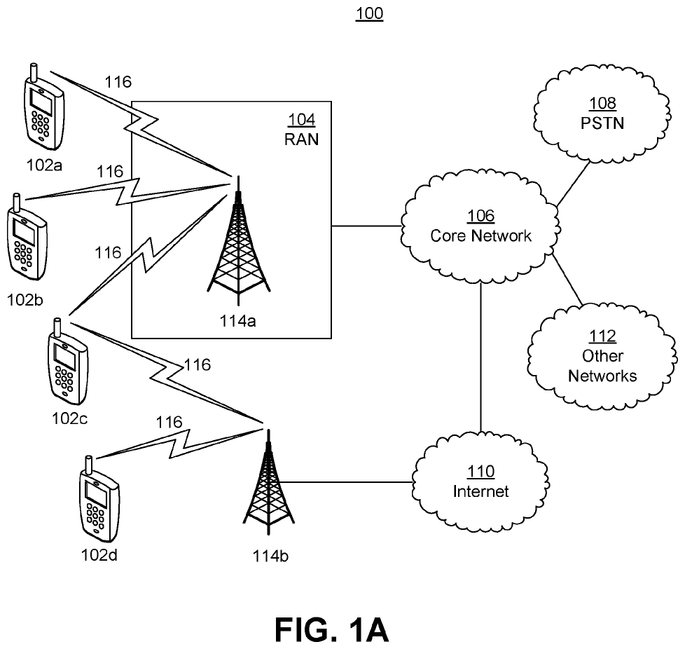

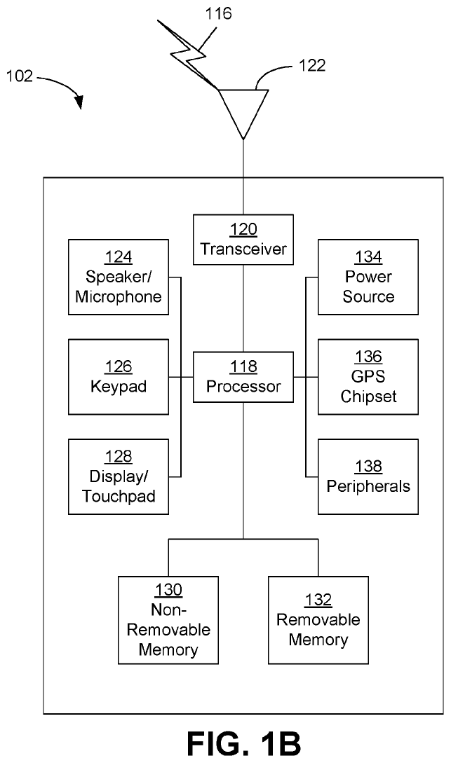

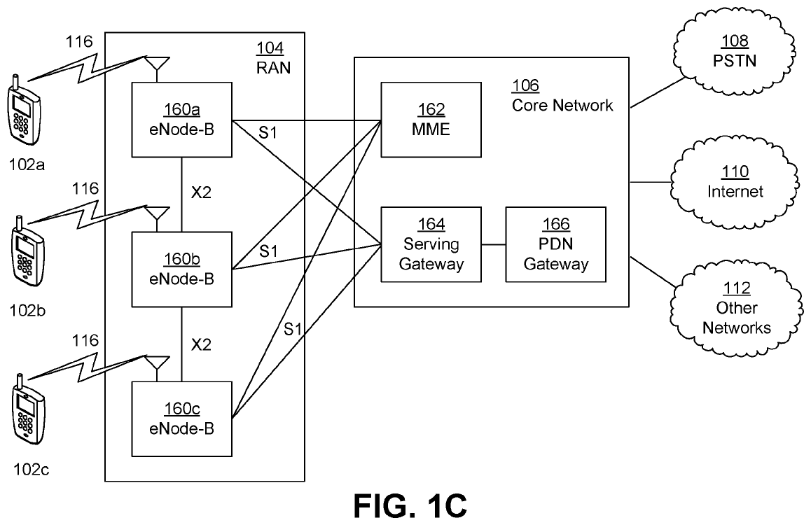

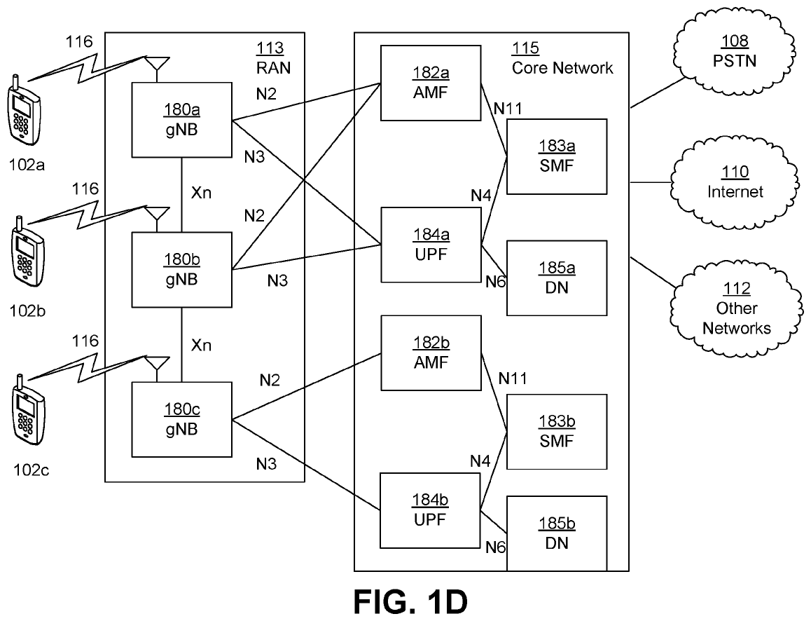

The methods, procedures, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

3GPP Release 17 (Rel-17) unified TCI framework supports one unified TCI (e.g., joint or a pair of separate DL/UL) that may be indicated/maintained at a WTRU (or UE), to be applicable for both control/data channels simultaneously, which is different from an individual beam control per channel (e.g., up to 3GPP Rel-16).

In 3GPP Rel-16 or Rel-17, multi-transmission/reception point (MTRP) is supported. In an example, multi-DCI based MTRP (MDCI-MTRP) is based on CORESETPoolIndex=0 or 1, to support eMBB. In another example, single-DCI based MTRP (SDCI-MTRP) is based on associating up to two TCI-states for a codepoint of TCI field in a DCI, for repeated transmissions across TRPs to achieve reliability enhancements.

In 3GPP Release 18, MIMO WID (e.g., RP-213598) captures one relevant aspect: specify extension of Rel-17 unified TCI framework for indication of multiple DL and UL TCI states focusing on multi-TRP use case, using Rel-17 unified TCI framework.

Continued evolution of 5G New Radio (NR) may continue to optimize management and enhance performance for wireless communications. Therefore, it is desired to 1) improve unified TCI application timeline in consideration of latency-critical channel(s)/signal(s), 2) improve robustness on unified TCI updates in case of reception error being occurred at WTRU(s) to receive the unified TCI, and/or 3) improve an accuracy and performance for coherent joint transmission (CJT) based operation(s) according to or using unified TCI updates.

Hereinafter, ‘a’ and ‘an’ and similar phrases are to be interpreted as ‘one or more’ and ‘at least one’. Similarly, any term which ends with the suffix ‘(s)’ is to be interpreted as ‘one or more’ and ‘at least one’. The term ‘may’ is to be interpreted as ‘may, for example’. A sign, symbol, or mark of forward slash ‘/’ is to be interpreted as ‘and/or’ unless particularly mentioned otherwise, where for example, ‘A/B’ may imply ‘A and/or B’.

### Overview

### Beam

In various embodiments, a WTRU may transmit or receive a physical channel or reference signal according to at least one spatial domain filter. The term “beam” may be used to refer to a spatial domain filter.

The WTRU may transmit a physical channel or signal using the same spatial domain filter as the spatial domain filter used for receiving a reference signal (RS) (e.g., a channel state information (CSI)-RS) or a synchronization signal (SS) block. The WTRU transmission may be referred to as “target”, and the received RS or SS block may be referred to as “reference” or “source”. In such case, the WTRU may be considered as to transmit the target physical channel or signal according to a spatial relation with a reference to such RS or SS block.

The WTRU may transmit a first physical channel or signal according to the same spatial domain filter as the spatial domain filter used for transmitting a second physical channel or signal. The first and second transmissions may be referred to as “target” and “reference” (or “source”), respectively. In such case, the WTRU may be considered as to transmit the first (target) physical channel or signal according to a spatial relation with a reference to the second (reference) physical channel or signal.

A spatial relation may be implicit, configured by radio resource control (RRC) message(s) or signaled by MAC control element (CE) or downlink control information (DCI). For example, a WTRU may implicitly transmit PUSCH and DM-RS of PUSCH according to the same spatial domain filter as a sounding reference signal (SRS) indicated by an SRS resource indicator (SRI) indicated in DCI or configured by RRC. In another example, a spatial relation may be configured by RRC for an SRI or signaled by MAC CE for a PUCCH. Such spatial relation may also be referred to as a “beam indication”.

The WTRU may receive a first (target) downlink channel or signal according to the same spatial domain filter or spatial reception parameter as a second (reference) downlink channel or signal. For example, such an association may exist between a physical channel (such as PDCCH or PDSCH) and its respective demodulation reference signal (DM-RS). At least when the first and second signals are reference signals, such an association may exist when the WTRU is configured with a quasi-colocation (QCL) assumption type D between corresponding antenna ports Such association may be configured as a transmission configuration indicator (TCI) state. A WTRU may be indicated an association between a CSI-RS or SS block and a DM-RS by an index to a set of TCI states configured by RRC and/or signaled by MAC CE. Such an indication may also be referred to as a “beam indication”.

### Unified TCI

A unified TCI (e.g., a common TCI, a common beam, a common RS, etc.) may refer to a beam/RS to be (simultaneously) used for multiple physical channels/signals. The term “TCI” may at least comprise a TCI state that includes at least one source RS to provide a reference (e.g., WTRU assumption) for determining QCL and/or spatial filter.

In an example, a WTRU may receive (e.g., from a gNB) an indication of a first unified TCI to be used/applied for both a downlink control channel (PDCCH) and a downlink shared channel (PDSCH) (e.g., and a downlink RS). The source reference signal(s) in the first unified TCI may provide common QCL information at least for WTRU-dedicated reception on the PDSCH and all (or subset of) CORESETs in a CC. In an example, a WTRU may receive (e.g., from a gNB) an indication of a second unified TCI to be used/applied for both an uplink control channel (PUCCH) and an uplink shared channel (PUSCH) (e.g., and an uplink RS). The source reference signal(s) in the second unified TCI may provide a reference for determining common UL Tx spatial filter(s) at least for dynamic-grant/configured-grant based PUSCH and all (or subset of) dedicated PUCCH resources in a CC.

The WTRU may be configured with a first mode for unified TCI (e.g., SeparateDLULTCI mode) where an indicated unified TCI (e.g., the first unified TCI or the second unified TCI) may be applicable for either downlink (e.g., based on the first unified TCI) or uplink (e.g., based on the second unified TCI).

In an example, a WTRU may receive (e.g., from a gNB) an indication of a second unified TCI to be used/applied commonly for a PDCCH, a PDSCH, a PUCCH, and a PUSCH (and a DL RS and/or a UL RS).

The WTRU may be configured with a second mode for unified TCI (e.g., JointTCI mode) where an indicated unified TCI (e.g., the third unified TCI) may be applicable for both downlink and uplink (e.g., based on the third unified TCI).

The WTRU may determine a TCI state applicable to a transmission or reception by first determining a Unified TCI state instance applicable to this transmission or reception, then determining a TCI state corresponding to the Unified TCI state instance. A transmission may consist of at least PUCCH, PUSCH, SRS. A reception may consist of at least PDCCH, PDSCH, CSI-RS. A Unified TCI state instance may also be referred to TCI state group, TCI state process, unified TCI pool, a group of TCI states, a set of time-domain instances/stamps/slots/symbols, and/or a set of frequency-domain instances/RBs/subbands, etc. A Unified TCI state instance may be equivalent or identified to a Coreset Pool identity (e.g., CORESETPoolIndex, a TRP indicator, and/or the like).

A unified TCI may be interchangeably used with one or more of unified TCI-states, unified TCI instance, TCI, and TCI-state, but still consistent with this invention.

### TRP, MTRP, M-TRP

A transmission and reception point (TRP) may be interchangeably used with one or more of a transmission point (TP), a reception point (RP), a radio remote head (RRH), a distributed antenna (DA), a base station (BS), a sector (of a BS), and a cell (e.g., a geographical cell area served by a BS), but still consistent with this invention. A multi-TRP may be interchangeably used with one or more of an MTRP, an M-TRP, and multiple TRPs, but still consistent with this invention.

### Configuration of TRPs, SRIs, And/or Pathloss (PL) Reference Signal(s)

A WTRU may be configured with (or may receive configuration of) one or more TRPs to which the WTRU may transmit and/or from which the WTRU may receive. The WTRU may be configured with one or more TRPs for one or more cells. A cell may be a serving cell, or a secondary cell.

A WTRU may be configured with at least one RS for the purpose of channel measurement. This RS may be denoted as a channel measurement resource (CMR) and may comprise a CSI-RS, an SSB, and/or other downlink RS(s) transmitted from the TRP to a WTRU. A CMR may be configured or associated with a TCI state. A WTRU may be configured with a CMR group where CMRs transmitted from the same TRP may be configured. Each group may be identified by a CMR group index (e.g., group 1). A WTRU may be configured with one CMR group per TRP, and the WTRU may receive a linkage between one CMR group index and another CMR group index, or between one RS index from one CMR group and another RS index from another group.

A WTRU may be configured with (or receive configuration of) one or more pathloss (PL) reference groups (e.g., sets) and/or one or more SRS groups, SRS resource indicator (SRI) or SRS resource sets.

A PL reference group may correspond to or may be associated with a TRP. A PL reference group may include, identify, correspond to or be associated with one or more TCI states, SRIs, reference signal sets (e.g. CSI-RS set, SRI sets), CORESET index, and or reference signals (e.g. CSI-RS, SSB).

A WTRU may receive a configuration (e.g., any configuration described herein). The configuration may be received from a gNB or TRP. For example, the WTRU may receive configuration of one or more TRPs, one or more PL reference groups and/or one or more SRI sets. A WTRU may implicitly determine an association between a RS set/group and a TRP. E.g., if the WTRU is configured with two SRS resource sets, then the WTRU may determine to transmit to TRP1 with SRS in the first resource set, and to TRP2 with SRS in the second resource set. The configuration may be via RRC signaling.

In the examples and embodiments described herein, a TRP, a PL reference group, an SRI group, and/or an SRI set may be used interchangeably. The terms set and group may be used interchangeably herein.

### CSI Components

A WTRU may report a subset of channel state information (CSI) components, where CSI components may correspond to at least a CSI-RS resource indicator (CRI), a SSB resource indicator (SSBRI), an indication of a panel used for reception at the WTRU (such as a panel identity or group identity), measurements such as L1-RSRP, L1-SINR taken from SSB or CSI-RS (e.g. cri-RSRP, cri-SINR, ssb-Index-RSRP, ssb-Index-SINR), and other channel state information such as at least rank indicator (RI), channel quality indicator (CQI), precoding matrix indicator (PMI), Layer Index (LI), and/or the like.

### Property of a Grant or Assignment

A property of a grant or assignment may comprise at least one of the following: a frequency allocation; an aspect of time allocation (e.g., a time duration); a priority; a modulation and coding scheme; a transport block size (TBS); a number of spatial layers; a number of transport blocks; a TCI state, CRI or SRI; a number of repetitions; whether the repetition scheme is Type A or Type B; whether the grant is a configured grant type 1, type 2 or a dynamic grant; whether the assignment is a dynamic assignment or a semi-persistent scheduling (configured) assignment; a configured grant index or a semi-persistent assignment index; a periodicity of a configured grant or assignment; a channel access priority class (CAPC); and/or any parameter provided in a DCI, by MAC or by RRC for the scheduling the grant or assignment.

An indication by DCI may comprise at least one of the following: 1) an explicit indication by a DCI field or by RNTI used to mask CRC of the PDCCH; and/or 2) an implicit indication by a property such as DCI format, DCI size, Coreset or search space, Aggregation Level, first resource element of the received DCI (e.g., index of first Control Channel Element), and the mapping between the property and the value may be signaled by an RRC message or an MAC (e.g., MAC CE) message.

A signal may be interchangeably used with one or more of the following: a sounding reference signal (SRS), a channel state information-reference signal (CSI-RS), a demodulation reference signal (DM-RS), a phase tracking reference signal (PT-RS), and/or a synchronization signal block (SSB).

A channel may be interchangeably used with one or more of the following: a physical downlink control channel (PDCCH), a physical downlink shared channel (PDSCH), a physical uplink control channel (PUCCH), a physical uplink shared channel (PUSCH), a physical random access channel (PRACH), etc.

Downlink reception may be used interchangeably with reception (Rx) occasion, PDCCH, PDSCH, SSB reception, but still consistent with this invention.

Uplink transmission may be used interchangeably with transmission (Tx) occasion, PUCCH, PUSCH, PRACH, SRS transmission, but still consistent with this invention.

An RS may be interchangeably used with one or more of an RS resource, an RS resource set, an RS port, and/or an RS port group, but still consistent with this invention. An RS may also be interchangeably used with one or more of an SSB, a CSI-RS, an SRS, and/or a DM-RS, but still consistent with this invention.

A time instance may be interchangeably used with a slot, a symbol, a subframe, but still consistent with this invention.

### Representative Procedures for Channel/Signal-Specific UTCI Timeline

In one embodiment, a WTRU may be configured with one or more parameters of beam application time (BAT), and each of the one or more parameters of BAT may be associated with a list of channel(s)/signal(s) which may be pre-defined, and/or determined based on WTRU capability, and/or configured (e.g., independently configured) by the network (e.g., by a gNB).

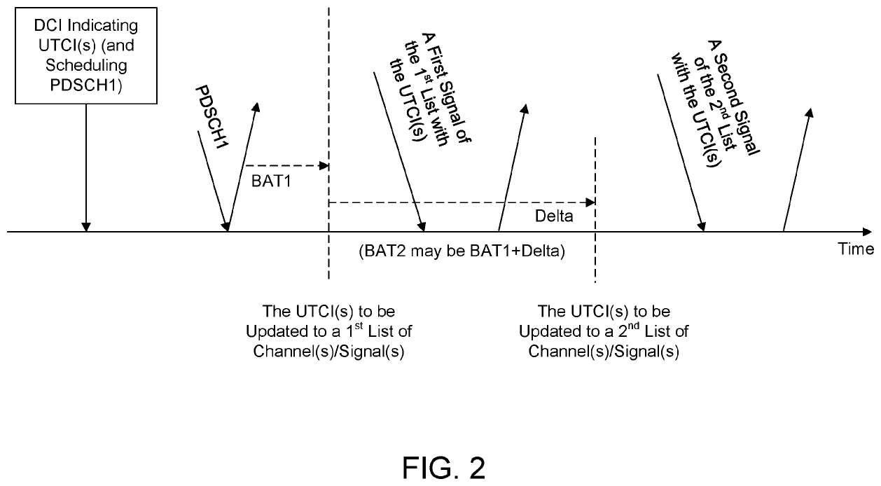

For example, referring to FIG. 2, a timeline of using one or more BATs (e.g., BAT1 and/or BAT2) or a paired/associated offset parameter (Delta) for indicated UTCI(s) is provided. In this example, when the association is configured by gNB, the association may be given by a higher-layer signaling (e.g., RRC and/or MAC-CE). In this example, the WTRU may be configured with a first BAT (BAT1) associated with a first list of channel(s)/signal(s), and be configured with a second BAT (BAT2) associated with a second list of channel(s)/signal(s). One or more of the following operations may apply.

BAT1 (e.g., shorter than BAT2) may be configured for one or more channels/signals that are latency-sensitive (e.g., at least a part of the first list of channels/signals). In an example, the first list of channel(s)/signal(s) may comprise a first group of CORESETs, a first group of CSI-RSs, a first group of PUCCH resources, a first set of PDSCHs (e.g., other than CJT-PDSCH), a first set of PUSCHs (other than STxMP PUSCH), and/or CJT-CSI-RS(s) or SRSs (e.g., for channel reciprocity), and so forth. The first set of one or more PDSCHs may comprise a PDSCH (e.g., scheduled by higher-layer such as a semi-persistent-scheduling(SPS)-PDSCH, or a dynamic-grant-based PDSCH) that carries a latency-sensitive (e.g., latency-critical) packet-type data (e.g., URLLC packet). The first set of one or more PUSCHs may comprise a PUSCH (e.g., scheduled by higher-layer such as a configured-grant(CG)-PUSCH, or a dynamic-grant-based PUSCH) that carries a latency-sensitive (e.g., latency-critical) packet-type data transmission (e.g., for URLLC) from the WTRU, and so forth.

In response to receiving a control command/message (e.g., via a DCI, via a TCI field of a DCI), at a first time instance (T1) indicating at least one unified TCI (UTCI), the WTRU may determine a second time instance (T2), based on the T1 and BAT1 (e.g., as T1+BAT1, or as T1+Alpha+BAT1), on which the WTRU may update (and may start to use) the indicated at least one UTCI for the first list of channel(s)/signal(s), and not update (at T2) the indicated at least one UTCI for other channels/signals not included in the first list.

In an example, the ‘Alpha’ may include a first time duration between T1 and a PDSCH reception time instance (when the PDSCH is scheduled by the DCI, where the WTRU may receive the PDSCH by using a previous (e.g., currently used, so far being used) UTCI(s) independent from the indicated at least one UTCI).

In an example, the ‘Alpha’ may include the first time duration plus a second time duration between the PDSCH reception time instance and a corresponding ACK transmission time instance, where the corresponding ACK transmission may be performed based on a PUCCH resource (e.g., for HARQ-ACK) that may carry information regarding whether the PDSCH is successfully received at the WTRU and/or the indicated at least one UTCI is successfully received at the WTRU.

BAT2 (e.g., larger than BAT1) may be configured for a second set of channel(s)/signal(s) that may not be latency-sensitive/critical, and/or may be to be used as a “recoverable” backup channel before falling into a beam-failure-recovery (BFR) procedure or a radio-link-recovery (RLM/RLF) procedure, and/or may need more CSI acquisition time upon receiving a DCI indicating at least one UTCI. The second set of channel(s)/signal(s) may be at least a part of the second list of channel(s)/signal(s). In an example, the second list of channel(s)/signal(s) may comprise a second group of CORESETs, a second group of CSI-RSs, a second group of PUCCH resources, CJT-PDSCH(s) (e.g., due to CSI acquisition time needed), a second set of one or more PDSCHs, STxMP PUSCH (for having SRS-based acquisition time for STxMP), and/or a second set of one or more PUSCHs, and so forth. The second set of one or more PDSCHs may comprise a PDSCH (e.g., scheduled by higher-layer such as a semi-persistent-scheduling(SPS)-PDSCH, or a dynamic-grant-based PDSCH) that carries a not-so-latency-sensitive packet-type data (e.g., eMBB packet). The second set of one or more PUSCHs may comprise a PUSCH (e.g., scheduled by higher-layer such as a configured-grant(CG)-PUSCH, or a dynamic-grant-based PUSCH) that carries a not-so-latency-sensitive packet-type data transmission (e.g., for eMBB) from the WTRU, and so forth.

In response to receiving a control command /essage (e.g., via a DCI, via a TCI field of a DCI), at a first time instance (T1) indicating at least one unified TCI (UTCI), the WTRU may determine a third time instance (T3), based on the T1 and BAT2 (e.g., as T1+BAT2, or as T1+Alpha+BAT2), on which the WTRU may update (and start to use) the indicated at least one UTCI for the second list of channel(s)/signal(s), and not update (at T3) the indicated at least one UTCI for other channels/signals not included in the second list.

In an example, the ‘Alpha’ may include a first time duration between T1 and a PDSCH reception time instance (when the PDSCH is scheduled by the DCI, where the WTRU may receive the PDSCH by using a previous (e.g., currently used, so far being used) UTCI(s) independent from the indicated at least one UTCI).

In an example, the ‘Alpha’ may include the first time duration plus a second time duration between the PDSCH reception time instance and a corresponding ACK transmission time instance, where the corresponding ACK transmission may be performed based on a PUCCH resource (e.g., for HARQ-ACK) that may carry information regarding whether the PDSCH is successfully received at the WTRU and/or the indicated at least one UTCI is successfully received at the WTRU.

The WTRU may transmit its WTRU-capability reporting contents which may comprise a WTRU-capability component/element related to the BAT1, where the WTRU may report its supported (e.g., implemented) application time (e.g., in terms of its hardware/software implementation-wise necessary time duration to update/apply the at least one UTCI upon being received by the DCI). Based on receiving this WTRU-capability reporting from the WTRU, a gNB may configure (or indicate) a parameter of BAT1 to the WTRU (e.g., at least for a confirmation based on receiving the WTRU-capability reporting). In response to receiving the parameter/value of BAT1, the WTRU may use the BAT1 (e.g., shorter than BAT2), based on at least one embodiment presented in this disclosure. In an example, the BAT2 may not be based on WTRU-capability reporting. The WTRU may receive the BAT2 and determine to use/apply the BAT2 for a particular set of channel(s)/signal(s) which may correspond to the second list of channel(s)/signal(s). The WTRU may be configured (or indicated) to use/apply the BAT2, even though the WTRU may determine the BAT2 is not based on the WTRU-capability reporting contents (e.g., its supported application time to update/apply the at least one UTCI upon being received by the DCI).

The BAT2 may be dynamically updated from the gNB, e.g., via a MAC-CE and/or a DCI to the WTRU, where this may provide benefits in that the BAT2 may not be based on WTRU capability but a controllable parameter for the particular set of channel(s)/signal(s).

The list of channel(s)/signal(s) associated with BAT1 may be mutually exclusive to the list of channel(s)/signal(s) associated with BAT2.

The list of channel(s)/signal(s) associated with BAT1 and BAT2 may be different based on availability of channel state information at the gNB for the indicated UTCI.

BAT2 may be updated to have the same value with BAT1 (e.g., BAT2=BAT1) when a WTRU reported CSI associated with the indicated UTCI within a time window before it receives the indicated UTCI or it is understood by WTRU that gNB has CSI information associated with the indicated UTCI. In some cases, the time window may be predetermined, configured, or indicated by a gNB.

In one embodiment, a WTRU may be configured with a BAT (e.g., a parameter of the BAT) and a paired/associated offset parameter of ‘Delta’, where each of the BAT and the ‘BAT plus Delta’ may be associated with a list of channel(s)/signals which may be predefined, determined based on WTRU capability, and/or configured (e.g., independently configured) by a gNB (e.g., as illustrated in FIG. 2). When the association is configured by the gNB, the association may be given by a higher-layer signaling (e.g., RRC and/or MAC-CE). In an example, the WTRU may be configured with the BAT associated with a first list of channel(s)/signal(s), and be configured with the Delta where the BAT plus Delta may be associated with a second list of channel(s)/signal(s). One or more of the following operations may apply.

The BAT may be used/applied for one or more channels/signals that are latency-sensitive (e.g., at least a part of the first list of channels/signals). In an example, the first list of channel(s)/signal(s) may comprise a first group of CORESETs, a first group of CSI-RSs, a first group of PUCCH resources, a first set of one or more PDSCHs (e.g., other than CJT-PDSCH), a first set of one or more PUSCHs (other than STxMP PUSCH), and/or CJT-CSI-RS(s) or SRSs (e.g., for channel reciprocity), and so forth. The first set of one or more PDSCHs may comprise a PDSCH (e.g., scheduled by higher-layer such as a semi-persistent-scheduling(SPS)-PDSCH, or a dynamic-grant-based PDSCH) that carries a latency-sensitive (e.g., latency-critical) packet-type data (e.g., URLLC packet). The first set of one or more PUSCHs may comprise a PUSCH (e.g., scheduled by higher-layer such as a configured-grant(CG)-PUSCH, or a dynamic-grant-based PUSCH) that carries a latency-sensitive (e.g., latency-critical) packet-type data transmission (e.g., for URLLC) from the WTRU, and so forth.

In response to receiving a control command /essage (e.g., via a DCI, via a TCI field of a DCI), at a first time instance (T1) indicating at least one unified TCI (UTCI), the WTRU may determine a second time instance (T2), based on the T1 and the BAT (e.g., as T1+BAT, or as T1+Alpha+BAT), on which the WTRU may update (and start to use) the indicated at least one UTCI for the first list of channel(s)/signal(s), and not update (at T2) the indicated at least one UTCI for other channels/signals not included in the first list.

In an example, the ‘Alpha’ may include a first time duration between T1 and a PDSCH reception time instance (when the PDSCH is scheduled by the DCI, where the WTRU may receive the PDSCH by using a previous (e.g., currently used, so far being used) UTCI(s) independent from the indicated at least one UTCI).

In an example, the ‘Alpha’ may include the first time duration plus a second time duration between the PDSCH reception time instance and a corresponding ACK transmission time instance, where the corresponding ACK transmission may be performed based on a PUCCH resource (e.g., for HARQ-ACK) that may carry information regarding whether the PDSCH is successfully received at the WTRU and/or the indicated at least one UTCI is successfully received at the WTRU.

The BAT plus Delta may be used/applied for a second set of channel(s)/signal(s) that may not be latency-sensitive/critical, and/or may be to be used as a “recoverable” backup channel before falling into a beam-failure-recovery(BFR) procedure or a radio-link-recovery(RLM) procedure, and/or may need more CSI acquisition time upon receiving a DCI indicating at least one UTCI. The second set of channel(s)/signal(s) may be at least a part of the second list of channel(s)/signal(s). In an example, the second list of channel(s)/signal(s) may comprise a second group of CORESETs, a second group of CSI-RSs, a second group of PUCCH resources, CJT-PDSCH(s) (e.g., due to CSI acquisition time needed), a second set of one or more PDSCHs, STxMP PUSCH (for having SRS-based acquisition time for STxMP), and/or a second set of one or more PUSCHs, and so forth. The second set of one or more PDSCHs may comprise a PDSCH (e.g., scheduled by higher-layer such as a semi-persistent-scheduling(SPS)-PDSCH, or a dynamic-grant-based PDSCH) that carries a not-so-latency-sensitive packet-type data (e.g., eMBB packet). The second set of one or more PUSCHs may comprise a PUSCH (e.g., scheduled by higher-layer such as a configured-grant(CG)-PUSCH, or a dynamic-grant-based PUSCH) that carries a not-so-latency-sensitive packet-type data transmission (e.g., for eMBB) from the WTRU, and so forth.

In response to receiving a control command/message (e.g., via a DCI, via a TCI field of a DCI), at a first time instance (T1) indicating at least one unified TCI (UTCI), the WTRU may determine a third time instance (T3), based on the T1, BAT, and Delta (e.g., as T1+BAT+Delta, or as T1+Alpha+BAT+Delta), on which the WTRU may update (and start to use) the indicated at least one UTCI for the second list of channel(s)/signal(s), and not update (at T3) the indicated at least one UTCI for other channels/signals not included in the second list.

In an example, the ‘Alpha’ may include a first time duration between T1 and a PDSCH reception time instance (when the PDSCH is scheduled by the DCI, where the WTRU may receive the PDSCH by using a previous (e.g., currently used, so far being used) UTCI(s) independent from the indicated at least one UTCI).

In an example, the ‘Alpha’ may include the first time duration plus a second time duration between the PDSCH reception time instance and a corresponding ACK transmission time instance, where the corresponding ACK transmission may be performed based on a PUCCH resource (e.g., for HARQ-ACK) that may carry information regarding whether the PDSCH is successfully received at the WTRU and/or the indicated at least one UTCI is successfully received at the WTRU.

The WTRU may transmit its WTRU-capability reporting contents which may comprise a WTRU-capability component/element related to the BAT, where the WTRU may report its supported (e.g., implemented) application time (e.g., in terms of its hardware/software implementation-wise necessary time duration to update/apply the at least one UTCI upon being received by the DCI). Based on receiving this WTRU-capability reporting from the WTRU, a gNB may configure (or indicate) a parameter of BAT to the WTRU (e.g., at least for a confirmation based on receiving the WTRU-capability reporting). In response to receiving the parameter/value of BAT, the WTRU may use the BAT, based on at least one embodiment presented in this disclosure. In an example, the Delta may not be based on WTRU-capability reporting. The WTRU may receive a value of the Delta and determine to use/apply the BAT plus Delta for a particular set of channel(s)/signal(s) which may correspond to the second list of channel(s)/signal(s). The WTRU may be configured (or indicated) to use/apply the BAT plus Delta, even though the WTRU may determine the Delta is not based on the WTRU-capability reporting contents (e.g., its supported application time to update/apply the at least one UTCI upon being received by the DCI).

The Delta may be dynamically updated from the gNB, e.g., via a MAC-CE and/or a DCI to the WTRU, where this may provide benefits in that the Delta may not be based on WTRU capability but a controllable parameter for the particular set of channel(s)/signal(s).

The list of channel(s)/signal(s) associated with BAT may be mutually exclusive to the list of channel(s)/signal(s) associated with BAT plus Delta.

The list of channel(s)/signal(s) associated with BAT and BAT plus Delta may be different based on availability of channel state information at the gNB for the indicated UTCI.

Delta may be updated to have ‘0’ value (e.g., Delta=0) when a WTRU reported CSI associated with the indicated UTCI within a time window before it receives the indicated UTCI or it is understood by WTRU that gNB has CSI information associated with the indicated UTCI. In some cases, the time window may be predetermined, configured, or indicated by a gNB.

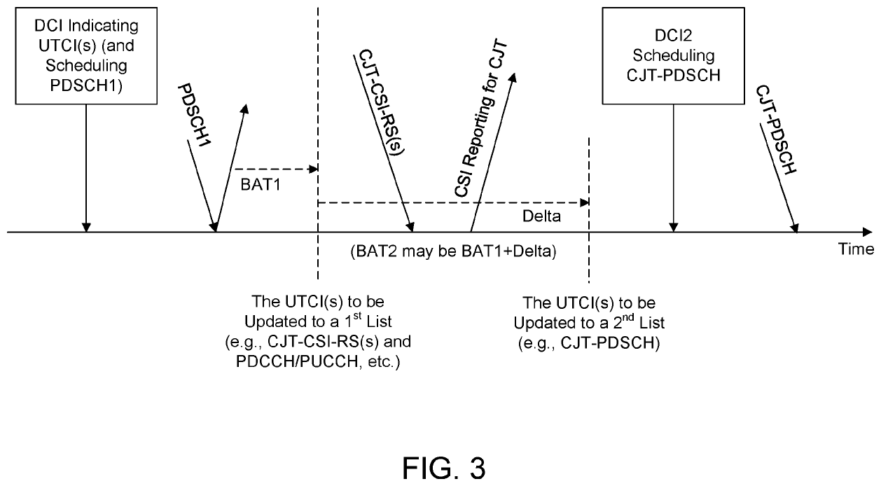

In one embodiment, referring to FIG. 3, a timeline of using one or more BATs (e.g., BAT1 and/or BAT2) or a paired/associated offset parameter (Delta) for a coherent joint transmission (CJT) operation is provided.

For example, the first list of channel(s)/signal(s) may be at least comprising one or more CSI-RS resources (e.g., being tagged for use of coherent joint transmission (CJT) operation, e.g., being enabled for the WTRU) which may be denoted by CJT-CSI-RS resources, and the second list of channel(s)/signal(s) may be at least comprising a PDSCH scheduled for the CJT operation, which may be denoted by CJT-PDSCH. This may provide benefits in terms of improving an accuracy and performance for the CJT operation in that a CSI acquisition time duration may be obtained between a first time instance where BAT1 (or the BAT) indicates and a second time instance where BAT2 (or the BAT plus Delta) indicates. In an example, up to Q TRPs may be considered for the CJT operation, e.g., Q=4. The WTRU may receive a DCI indicating at least one UTCI (e.g., 2 UTCIs, where UTCI1 corresponds to a first TRP out of the Q TRPs, and UTCI2 corresponds to a second TRP out of the Q TRPs). The first TRP may be one among TRP index 1, 2, 3, and 4, and the second TRP may be one among TRP index 1, 2, 3, and 4 and different from the first TRP. This TRP selection mechanism may be accommodated in the DCI based indication, indicating the at least one UTCI, in terms of CJT operation. The WTRU may determine that, at the first time instance, UTCI1 is to be applied on a first CSI-RS resource (for CJT operation) and UTCI2 is to be applied on a second CSI-RS resource (for CJT operation). Based on the determination, the WTRU may measure the first CSI-RS resource by using UTCI1 and the second CSI-RS resource by using UTCI2, and may transmit one or more CSI reporting contents (for CJT operation) based on the measurement. The WTRU may receive a PDSCH (e.g., the CJT-PDSCH) at or after the second time instance, where the PDSCH (e.g., the CJT-PDSCH) may be scheduled based on the one or more CSI reporting contents being received at the gNB (e.g., as illustrated in FIG. 3).

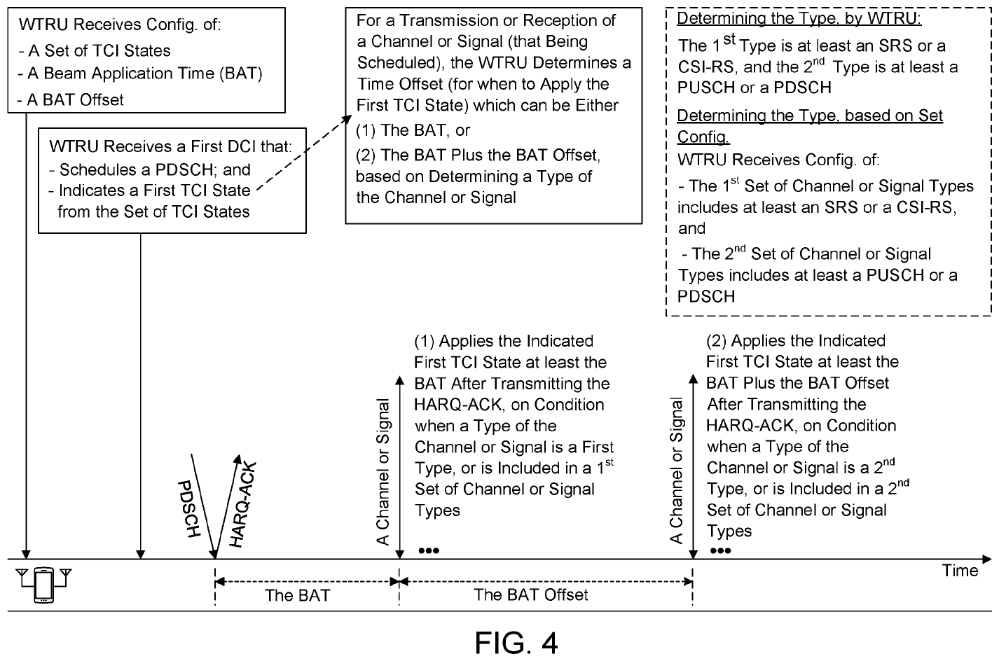

In one embodiment, referring to FIG. 4, an example of a timeline management procedure is provided. In this example, the timeline management procedure may include determining (e.g., using TCI indications) a type of a channel (or signal) for wireless communications.

Referring to FIG. 4, for example, a WTRU may receive (e.g., from a gNB, a second WTRU, another WTRU for sidelink communication, or other transmitter(s) or node(s)) configuration information indicating a set of TCI states, a BAT, and/or a BAT offset (e.g., the Delta). The WTRU may receive a first DCI scheduling a PDSCH and indicating a first TCI state from the set of TCI states. The WTRU may apply the indicated first TCI state to a transmission (or reception) of a channel or signal (e.g., a channel or signal being scheduled, configured, or indicated) when the channel or signal is transmitted (or received) at a time offset (or at least a time offset, or using one or more time offsets) after transmitting an ACK associated with reception of the PDSCH transmission.

In an example, the WTRU may determine that the time offset is the BAT when a type of the channel or signal is a first type of channel or signal (or is included in a first set of channel or signal types). The WTRU may determine that the time offset is the BAT plus the BAT offset (e.g., BAT+BAT offset) when the type of the channel or signal is a second type of channel or signal (or is included in a second set of channel or signal types). In an example, the WTRU may transmit (or receive) the channel or signal using the indicated first TCI state, based on (or using) the determined time offset (e.g., the BAT, or the BAT plus the BAT offset), on condition that the channel or signal is transmitted (or received) at least the determined time offset after transmitting an ACK associated with reception of the PDSCH.

In an example, the WTRU may determine: i) the first type of channel or signal is at least one of an SRS or a CSI-RS (e.g., for channel acquisition) or a data channel associated with a low-latency related type (e.g., URLLC), and ii) the second type of channel or signal is at least one of a PUSCH or a PDSCH or a control channel (e.g., CORESET, PDCCH, search space, or PUCCH) associated with a recovery purpose discussed herein.

In an example, the WTRU may receive configuration information indicating: i) the first set of channel or signal types includes at least one of an SRS or a CSI-RS (e.g., for channel acquisition) or a data channel associated with a low-latency related type (e.g., URLLC), and ii) the second set of channel or signal types includes at least one of a PUSCH or a PDSCH or a control channel (e.g., CORESET, PDCCH, search space, or PUCCH) associated with a recovery purpose discussed herein.

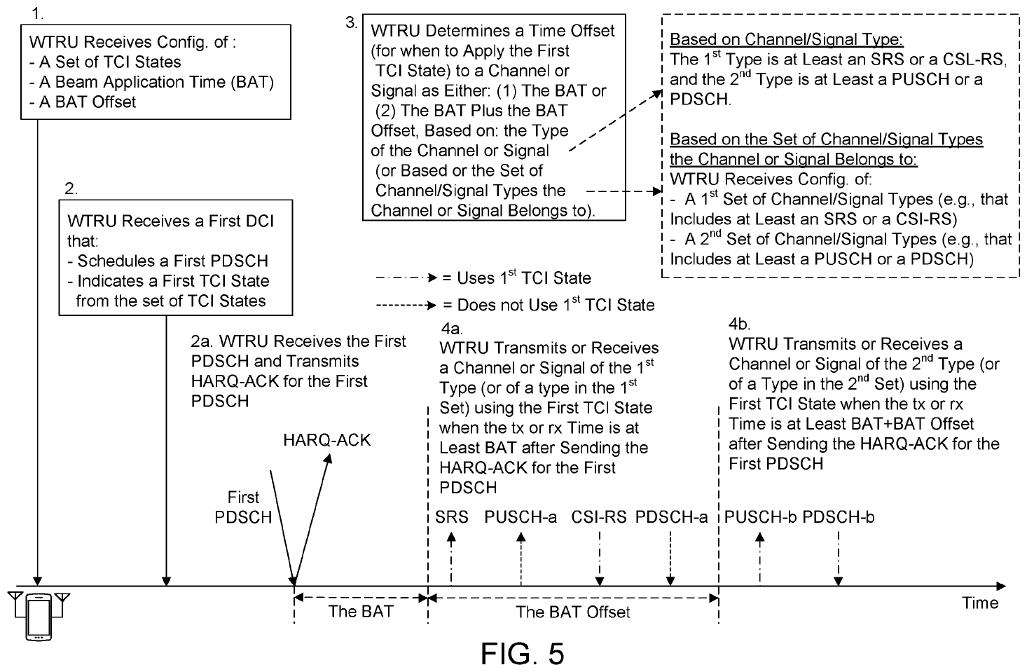

In one embodiment, referring to FIG. 5, an example of a transmission/reception management procedure is provided. In this example, a timeline management procedure may include determining (e.g., using TCI indications) type(s) of channel(s) or signal(s) and using time offset(s) for wireless communications.

Referring to FIG. 4, for example, a WTRU may receive (e.g., from a gNB, a second WTRU, another WTRU for sidelink communication, or other transmitter(s) or node(s)) configuration information indicating a set of TCI states, a BAT, and/or a BAT offset (e.g., the Delta). The WTRU may receive a first DCI scheduling a PDSCH and indicating a first TCI state from the set of TCI states. The WTRU may apply the indicated first TCI state to a transmission (or reception) of a channel or signal (e.g., a channel or signal being scheduled, configured, or indicated) when the channel or signal is transmitted (or received) at a time offset (or at least a time offset, or using one or more time offsets) after transmitting a HARQ feedback (e.g., a HARQ-ACK) associated with reception of the PDSCH transmission.

The WTRU may determine a time offset (e.g., for when to apply the first TCI state) to a channel or signal as either: the BAT, or the BAT plus the BAT offset. This determination of using 1) BAT or 2) BAT plus BAT offset is based on the type of the channel or signal, or based on the set of channel/signal types the channel or signal belongs to. For example, the determination is based on the channel/signal type: the first type is at least an SRS or a CSI-RS, and the second type is at least a PUSCH or a PDSCH. In another example, the determination is based on the set of channel/signal types the channel or signal belongs to: a first set of channel/signal types (e.g., that includes at least a SRS or a CSI-RS), or a second set of channel/signal types (e.g., that includes at least a PUSCH or a PDSCH).

In an example, the WTRU may transmit a channel (or signal) of the first type (or of a type in the first set) using the first TCI state when the transmission time is at least BAT after sending the HARQ feedback (e.g., HARQ-ACK) for the first PDSCH. In this example, the first type of signal (or of a type in the first set) may be an SRS or a CSI-RS.

In another example, the WTRU may receive a channel (or signal) of the first type (or of a type in the first set) using the first TCI state when the reception time is at least BAT after sending the HARQ feedback (e.g., HARQ-ACK) for the first PDSCH. In this example, the first type of signal (or of a type in the first set) may be an SRS or a CSI-RS.

In an example, the WTRU may transmit a channel (or signal) of the second type (or of a type in the second set) using the first TCI state when the transmission time is at least BAT plus BAT offset after sending the HARQ feedback (e.g., HARQ-ACK) for the first PDSCH. In this example, the second type of channel (or of a type in the second set) may be a PUSCH or a second PDSCH.

In another example, the WTRU may receive a channel (or signal) of the second type (or of a type in the second set) using the first TCI state when the reception time is at least BAT plus BAT offset after sending the HARQ feedback (e.g., HARQ-ACK) for the first PDSCH. In this example, the second type of channel (or of a type in the second set) may be a PUSCH or a second PDSCH.

In one embodiment, a WTRU may receive configuration information indicating a set of transmission configuration indicator (TCI) states, a beam application time (BAT), and/or a BAT offset. The WTRU may receive downlink control information (DCI) indicating 1) scheduling of a downlink data transmission and 2) a TCI state from the set of TCI states. The WTRU may determine, based on a type of a channel to be used after transmitting a HARQ feedback associated with the downlink data transmission, a time offset associated with a time instance to apply the indicated TCI state. The WTRU may also transmit or receive, based on the determined time offset, a signal on the type of the channel and using the indicated TCI state.

In one example, the WTRU may determine that the time offset is the BAT based on the type of the channel being any of: an SRS, a CSI-RS, or a data channel associated with a low-latency related type. In another example, the WTRU may determine that the time offset is the BAT plus the BAT offset based on the type of the channel being any of: a PUSCH, a PDSCH, or a control channel.

### Representative Procedures for UTCI Timeline Based on UTCI Modes, TRPs, WTRU-panels

In one embodiment, a WTRU may be configured with more than one set of BAT values, In each respective set, more than one BAT (e.g., or one BAT plus Delta) may be configured. To define the overall structure of BAT configuration, a hierarchical configuration level may be considered and used for configuration(s) for the WTRU.

For example, a multi-stage or hierarchical BAT configuration may comprise one or more of the following steps or operations.

Per UTCI mode configuration: The first step of the configuration may be to define whether the UTCI mode is joint (e.g., UTCI for joint DL and UL) or separate (e.g., separated UTCIs each for either DL or UL). In a joint UTCI configuration, a WTRU may be configured with a same beam reference for all uplink and downlink channels or signal. Alternatively, a separate UTCI configuration may be configured with separate UTCI configuration per downlink and uplink transmission. UTCI-based operation may be configured per TRP, such that a WTRU may assume a separate UTCI mode of operation for a first TRP, e.g., serving TRP, and joint UTCI mode of operation for a second TRP. According to the UTCI mode of configuration, a WTRU may receive multiple sets of BAT values.

Per TRP/panel BAT configuration: According to gNB and WTRU implementation, a WTRU may receive more than one set of BAT values.

In one embodiment, a WTRU may receive more than one set of BAT values when it is configured in a multi-TRP transmission. A same set of BAT values may be used for more than one TRP. For example, BAT_set1 may be used for TRP1, while BAT_set2 may be used for TRP2 and TRP3.

In another embodiment, a WTRU may receive more than one set of BAT values when it indicates multi-panel transmission capability. The same set of BAT values may be used for more than one panel (e.g., WTRU-panel). For example, BAT_set1 may be used for a first panel, while BAT_set2 may be used for a second and third panel. A similar concept may be employed per WTRU antenna group as well.

In one embodiment, if a WTRU is configured to operate in a multi-TRP scenario, and it is configured with more than one BAT value, a WTRU may apply the larger BAT value for CJT operation. For example, if a WTRU is configured with BAT1 for PDSCH transmission from TRP1, and BAT2 for PDSCH transmission from TRP2, where BAT2>BAT1, the WTRU may assume BAT2 for a CJT transmission (e.g., CJT-PDSCH).

In one embodiment, if a WTRU is configured to operate in a multi-TRP scenario, and it is configured with one BAT plus Delta, a WTRU may apply the BAT plus Delta for CJT operation. For example, if a WTRU is configured with BAT for PDSCH transmission from TRP1, and BAT plus Delta for PDSCH transmission from TRP2, based on the Delta (e.g., a positive value), the WTRU may assume BAT plus Delta for a CJT transmission (e.g., CJT-PDSCH).

Similarly, if a multi-panel WTRU is configured to operate in STxMP, and it is configured with more than one BAT values, a WTRU may apply the larger BAT value for an STxMP operation. For example, if a multi-panel WTRU is configured with BAT1 for PUSCH transmission from a first panel, and BAT2 for PUSCH transmission from a second panel, where BAT2>BAT1, the WTRU may assume (and use/apply) BAT2 for the STxMP transmission. If a multi-panel WTRU is configured to operate in STxMP, and it is configured with one BAT plus Delta, a WTRU may apply the BAT plus Delta for an STxMP operation. For example, if a multi-panel WTRU is configured with the BAT for PUSCH transmission from a first panel, and the BAT plus Delta for PUSCH transmission from a second panel, based on the Delta (e.g., a positive value), the WTRU may assume (and use/apply) the BAT plus Delta for the STxMP transmission.

Per channel configuration: Once WTRU is configured with at least one set of BAT values, e.g., according to TRP or WTRU panel. Then, the configured set value may be divided to more than one subset according to channel and/or signals.

In one embodiment, a WTRU configured with BAT_set1 for TRP1, may receive more than one subset of BAT values where each subset of BAT values may be used for more than one channel and/or signals. For example, in a multi-DCI TRP transmission, for a same channel, e.g., PDCCH, there may be two different BAT values, e.g., BAT11 and BAT21 may be considered where BAT11 and BAT21 values are the BAT values correspond to the TRP1 and TRP2.

In one embodiment, for a given channel/signal, the BAT values correspond to the TRP associated to the serving cell may be shorter than the BAT values associated to other TRPs.

In one embodiment, a hierarchical BAT configuration for a multi-panel WTRU configured in a multi-TRP deployment may be based on a combination of semi-static and dynamic signaling.

In one embodiment, the general UTCI mode configuration as whether a separate or a joint TCI mode may be done through RRC signaling. In one embodiment, the joint TCI configuration may be considered as the fall back mode.

For per TRP/panel BAT configuration, a combined use of semi-static and dynamic signaling may be used. In one embodiment, a WTRU may be configured with more than one per TRP and/or per panel BAT configuration where a particular selection may be done by dynamic signaling, e.g., MAC CE or a DCI.

Similarly to the per TRP/per panel, for per channel configuration, a combined use of semi-static and dynamic signaling may be used. In one embodiment, a WTRU may be configured with more than one per channel/signal configuration where a particular selection may be made by dynamic signaling, e.g., MAC CE or a DCI.

### Representative Procedures for Timeline Management on Unified TCI

In representative embodiments, a WTRU may be configured with a parameter of beam application time (BAT) and a paired/associated offset parameter of ‘Delta’, where each of the BAT and the ‘BAT plus Delta’ may be associated with a list of channel(s)/signals which may be predefined, determined based on WTRU capability, and/or configured independently by the network (e.g., by a gNB). In an example, the WTRU may be configured with the BAT associated with a first list of channel(s)/signal(s), and be configured with the Delta where the BAT plus Delta may be associated with a second list of channel(s)/signal(s).

In an example, in response to receiving a control message (e.g., via a DCI, or via a TCI field of a DCI), at a first time instance (T1) indicating at least one unified TCI (UTCI), the WTRU may determine a second time instance (T2), based on the T1 and the BAT (e.g., as T1+BAT, or as T1+Alpha+BAT), on which the WTRU may update (e.g., set, and/or start to use) the indicated at least one UTCI for the first list of channel(s)/signal(s), and not update (at T2) the indicated at least one UTCI for other channels/signals not included in the first list.

In an example, the WTRU may determine a third time instance (T3), based on the T1, BAT, and Delta (e.g., as T1+BAT+Delta, or as T1+Alpha+BAT+Delta), on which the WTRU may update (e.g., set, and/or start to use) the indicated at least one UTCI for the second list of channel(s)/signal(s), and not update (at T3) the indicated at least one UTCI for other channels/signals not included in the second list.

In representative embodiments, a WTRU determines that the time offset is the BAT when (or based on) a type of the channel (or signal) is a first type of channel (or signal) or is included in a first set of channel (or signal) types. The WTRU may determine that the time offset is the BAT plus the BAT offset when the type of the channel or signal is a second type of channel or signal or is included in a second set of channel or signal types. In an example, the WTRU may determine i) the first type of channel or signal is at least one of an SRS or a CSI-RS (e.g., for channel acquisition) or a data channel associated with a low-latency related type (e.g., URLLC) and ii) the second type of channel or signal is at least one of a PUSCH, a PDSCH, or a control channel (e.g., CORESET, PDCCH, search space, or PUCCH, etc.).

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

A processor in association with software may be used to implement a radio frequency transceiver for use in a wireless transmit receive unit (WTRU), user equipment (UE), terminal, base station, Mobility Management Entity (MME) or Evolved Packet Core (EPC), or any host computer. The WTRU may be used conjunction with modules, implemented in hardware and/or software including a Software Defined Radio (SDR), and other components such as a camera, a video camera module, a videophone, a speakerphone, a vibration device, a speaker, a microphone, a television transceiver, a hands free headset, a keyboard, a Bluetooth® module, a frequency modulated (FM) radio unit, a Near Field Communication (NFC) Module, a liquid crystal display (LCD) display unit, an organic light-emitting diode (OLED) display unit, a digital music player, a media player, a video game player module, an Internet browser, and/or any Wireless Local Area Network (WLAN) or Ultra Wide Band (UWB) module.

Although the invention has been described in terms of communication systems, it is contemplated that the systems may be implemented in software on microprocessors/general purpose computers (not shown). In certain embodiments, one or more of the functions of the various components may be implemented in software that controls a general-purpose computer.

What is claimed is:

1-23. (canceled)

24. A wireless transmit/receive unit (WTRU) for wireless communications, comprising circuitry, including a processor, a receiver, a transmitter, and memory, configured to:
receive configuration information indicating a set of transmission configuration indicator (TCI) states, a beam application time (BAT), and a BAT offset;
receive downlink control information (DCI) indicating 1) scheduling of a downlink data transmission and 2) a TCI state from the set of TCI states; and
transmit a first transmission using a previously identified TCI state, wherein the first transmission is transmitted on at least a first time offset associated with the BAT after transmitting a hybrid automatic repeat request (HARQ) feedback associated with the downlink data transmission; and
transmit a second transmission using the indicated TCI state, wherein the second transmission is transmitted on at least a second time offset associated with the BAT and the BAT offset after transmitting the HARQ feedback associated with the downlink data transmission.

25. The WTRU of claim 24, wherein the processor is configured to receive one or more of the configuration information or the DCI using the previously identified TCI state.

26. The WTRU of claim 24, wherein the BAT and BAT offset are channel specific.

27. The WTRU of claim 24, wherein the processor is configured to apply the indicated TCI state by associating the time offset with a time instance.

28. The WTRU of claim 27, wherein the processor is configured to determine that the time offset is the BAT based on the transmission comprising a first type of signal or channel.

29. The WTRU of claim 28, wherein the first type of signal or channel comprises one or more of a sounding reference signal (SRS), a channel state information—reference signal (CSI-RS), a demodulation reference signal (DM-RS), a phase tracking reference signal (PT-RS), or a synchronization signal block (SSB).

30. The WTRU of claim 29, wherein the processor is configured to determine that the time offset is a combination of the BAT and the BAT offset based on the transmission comprising a second type of signal or channel that is different from the first type of signal or channel,
wherein the second type of signal or channel comprises one or more of a physical downlink control channel (PDCCH), a physical downlink shared channel (PDSCH), a physical uplink control channel (PUCCH), a physical uplink shared channel (PUSCH), or a physical random access channel (PRACH).

31. The WTRU of claim 24, wherein the processor is configured to receive the configuration information via a radio resource control (RRC) signal or an MAC control element (CE).

32. The WTRU of claim 24, wherein the configuration information indicates a set of channel types or signal types.

33. The WTRU of claim 32, wherein the set of channel types or signal types comprises one or more of a sounding reference signal (SRS), a channel state information—reference signal (CSI-RS), a demodulation reference signal (DM-RS), a phase tracking reference signal (PT-RS), a synchronization signal block (SSB), a physical downlink control channel (PDCCH), a physical downlink shared channel (PDSCH), a physical uplink control channel (PUCCH), a physical uplink shared channel (PUSCH), or a physical random access channel (PRACH).

34. A method implemented by a wireless transmit/receive unit (WTRU) for wireless communications, the method comprising:
receiving configuration information indicating a set of transmission configuration indicator (TCI) states, a beam application time (BAT), and a BAT offset;
receiving downlink control information (DCI) indicating 1) scheduling of a downlink data transmission and 2) a TCI state from the set of TCI states; and
transmitting a first transmission using a previously identified TCI state, wherein the first transmission is transmitted on at least a first time offset associated with the BAT after transmitting a hybrid automatic repeat request (HARQ) feedback associated with the downlink data transmission; and
transmitting a second transmission using the indicated TCI state, wherein the second transmission is transmitted on at least a second time offset associated with the BAT and the BAT offset after transmitting the HARQ feedback associated with the downlink data transmission.

35. The method of claim 34, wherein one or more of the configuration information or the DCI is received using the previously identified TCI state.

36. The method of claim 34, wherein the BAT and the BAT offset are channel specific.

37. The method of claim 34, wherein the time offset is associated with a time instance to apply the indicated TCI state.

38. The method of claim 34, further comprising determining that the time offset is the BAT based on the transmission comprising a first type of signal or channel.

39. The method of claim 38, wherein the first type of signal or channel comprises one or more of a sounding reference signal (SRS), a channel state information—reference signal (CSI-RS), a demodulation reference signal (DM-RS), a phase tracking reference signal (PT-RS), or a synchronization signal block (SSB).

40. The method of claim 39, further comprising determining that the time offset is a combination of the BAT and the BAT offset based on the transmission comprising a second type of signal or channel that is different from the first type of signal or channel;
wherein the second type of signal or channel comprises one or more of a physical downlink control channel (PDCCH), a physical downlink shared channel (PDSCH), a physical uplink control channel (PUCCH), a physical uplink shared channel (PUSCH), or a physical random access channel (PRACH).

41. The method of claim 34, wherein the configuration information is received via a radio resource control (RRC) signal or an MAC control element (CE).

42. The method of claim 34, wherein the configuration information indicates a set of channel types or signal types.

43. The method of claim 42, wherein the set of channel types or signal types comprises one or more of a sounding reference signal (SRS), a channel state information—reference signal (CSI-RS), a demodulation reference signal (DM-RS), a phase tracking reference signal (PT-RS), a synchronization signal block (SSB); a physical downlink control channel (PDCCH), a physical downlink shared channel (PDSCH), a physical uplink control channel (PUCCH), a physical uplink shared channel (PUSCH), or a physical random access channel (PRACH).
